(19) United States
(12) Patent Application Publication
(10) Pub. No.: US 2026/0210476 A1
(43) Pub. Date: Jul. 23, 2026

(54) THERMAL INSULATION STRUCTURE FOR PIPE, PIPE HEATING SYSTEM, THERMAL INSULATION SHEET, AND METHOD OF INSTALLING THERMAL INSULATION STRUCTURE

(71) Applicants: TOKYO ELECTRON LIMITED, Tokyo (JP); NICHIAS CORPORATION, Tokyo (JP)

(72) Inventors: Eiichi KOMORI, Nagoya-shi (JP); Tsuneyuki OKABE, Nagoya-shi (JP); Akira SASAKI, Tokyo (JP); Keiichi FUKUDA, Tokyo (JP); Daisaku SEKI, Tokyo (JP); Takafumi WATANABE, Tokyo (JP); Hiroki OOTAKE, Tokyo (JP); Kouhei HOTTA, Tokyo (JP); Kenya MATSUO, Tokyo (JP)

(73) Assignees: TOKYO ELECTRON LIMITED, Tokyo (JP); NICHIAS CORPORATION, Tokyo (JP)

(21) Appl. No.: 19/140,188

(22) PCT Filed: Dec. 21, 2023
(86) PCT No.: PCT/JP2023/045968

§ 371 Date: Jun. 17, 2025

(30) Foreign Application Priority Data
Dec. 22, 2022 (JP) 2022-205875

(51) Int. Cl. F16L 53/38; F16L 59/07

(52) U.S. Cl. CPC F16L 53/38; F16L 59/07

(57) ABSTRACT

A thermal insulation structure includes a first thermal insulation sheet and a second thermal insulation sheet that are each configured to cover an outside of a heater mounted to a pipe, and ensure an air layer between the heater and each of the first thermal insulation sheet and the second thermal insulation sheet. Positions of the first thermal insulation sheet and second thermal insulation sheet are fixed with respect to the heater by a fastening portion. According to this structure, power consumption of the heater can be reduced while maintaining the already installed heater.

### TECHNICAL FIELD

The present invention relates to a thermal insulation structure for a pipe, a pipe heating system, a thermal insulation sheet, and a method of installing a thermal insulation structure.

### BACKGROUND ART

In a thin film forming step, an etching step, and other steps in manufacture of semiconductors or flat panel displays, various gases are used, and exhaust gases are generated. In order to prevent those gases from condensing and precipitating inside a pipe, a jacket heater that covers the pipe is sometimes used.

### CITATION LIST

### Patent Literature

[PTL 1] JP 2007-292199 A
[PTL 2] WO 2012/077648 A1

### SUMMARY OF INVENTION

### Technical Problem

In order to reduce manufacturing cost and reduce load on the environment due to manufacturing, it is important to reduce power consumption in manufacturing facilities, and the jacket heater mounted to the pipe is also required to reduce power consumption. It is possible to reduce the power consumption by increasing a thickness of a thermal insulation material of the jacket heater itself. However, to that end, it is required to replace the already installed jacket heater with a jacket heater having a thicker thermal insulation material, and such replacement is not preferred from the viewpoint of cost and workability. Further, increasing the thickness of the thermal insulation material is not preferred from the viewpoint of ease of installing the heater and saving a space for an apparatus including the heater and pipes.

### Solution to Problem

(1) A thermal insulation structure for a pipe, which is proposed in the present disclosure, includes: one or more thermal insulation sheets configured to cover an outside of a heater mounted to a pipe, and to ensure an air layer between the heater and the one or more thermal insulation sheets; and at least one fastening portion that is configured to fix a position of the one or more thermal insulation sheets with respect to the heater while ensuring the air layer, and to allow the one or more thermal insulation sheets to be attached to and detached from the heater. This thermal insulation structure may be applied not only to a pipe in semiconductor manufacturing facilities but also to a pipe in other facilities.

According to this structure, power consumption of the heater can be reduced while maintaining the already installed heater. Further, since the air layer is used, sufficient thermal insulation performance can be ensured while reducing a thickness of the thermal insulation sheet.
(2) In the thermal insulation structure according to item (1), the one or more thermal insulation sheets may include, as the at least one fastening portion, a first fastening portion and a second fastening portion that are attachable to and detachable from each other, and the position of the one or more thermal insulation sheets may be fixed with respect to the heater by attaching the first fastening portion and the second fastening portion to each other. According to this structure, since the first fastening portion and the second fastening portion are attachable to and detachable from each other, the installation work for the thermal insulation structure can be facilitated.
(3) In the thermal insulation structure according to item (2), the one or more thermal insulation sheets may include a first edge portion and a second edge portion located opposite to each other in a circumferential direction of the pipe. The first fastening portion and the second fastening portion may be mounted to the first edge portion and the second edge portion, respectively.
(4) In the thermal insulation structure according to any one of items (1) to (3), the pipe may include: a first partial pipe and a second partial pipe that are connected to each other in a length direction of the pipe; and joint portions that are arranged at an end portion of the first partial pipe and at an end portion of the second partial pipe, and have an outer diameter larger than an outer diameter of each of the first partial pipe and the second partial pipe. In this case, the joint portion may be located inside the one or more thermal insulation sheets. According to this structure, the air layer can be easily ensured.
(5) In the thermal insulation structure according to any one of items (1) to (3), the pipe may include a plurality of partial pipes that are connected to each other in a length direction of the pipe, each of the plurality of partial pipes includes a first joint portion and a second joint portion that are respectively provided at one end portion and another end portion of each partial pipe so as to connect each partial pipe to an adjacent partial pipe. The one or more thermal insulation sheets may be arranged between the first joint portion and the second joint portion.
(6) In the thermal insulation structure according to item (2) or (3), the first fastening portion and the second fastening portion may include at least one of a hook-and-loop fastener, a magnet, or a hook.
(7) In the thermal insulation structure according to any one of items (1) to (6), the at least one fastening portion may include at least one of a band or a string that is configured to be wrapped around an outside of the one or more thermal insulation sheets to fix the position of the one or more thermal insulation sheets with respect to the heater.
(8) In the thermal insulation structure according to item (2), (3), or (6), the one or more thermal insulation sheets may include a first thermal insulation sheet including the first edge portion provided with the first fastening portion, and a second thermal insulation sheet including the second edge portion provided with the second fastening portion. The first thermal insulation sheet and the second thermal insulation sheet may be connected to each other in the circumferential direction of the pipe through use of the first fastening portion and the second fastening portion. This can increase a structural flexibility of the pipe to which the thermal insulation structure is applicable.
(9) In the thermal insulation structure according to item (8), the first fastening portion and the second fastening portion may protrude in a radial direction of the pipe and face each other in the circumferential direction of the pipe to be attached to each other. According to this structure, even when this thermal insulation structure is applied to a location with a branch pipe, widths of the first fastening portion and the second fastening portion (widths in the radial direction of the pipe) can be ensured sufficiently. As a result, a gap between two thermal insulation sheets can be reduced even at the location with a branch pipe.
(10) In the thermal insulation structure according to any one of items (1) to (9), the one or more thermal insulation sheets may include a first thermal insulation sheet and a third thermal insulation sheet connected to each other in a length direction of the pipe. The first thermal insulation sheet may include a third edge portion in the length direction of the pipe, and a third fastening portion provided at the third edge portion. The third thermal insulation sheet may include a fourth edge portion in the length direction of the pipe, and a fourth fastening portion provided at the fourth edge portion. The third fastening portion and the fourth fastening portion may be attached to each other. According to this structure, installing the thermal insulation structure can be facilitated.
(11) In the thermal insulation structure according to item (10), the pipe may include: a first partial pipe and a second partial pipe that are connected to each other in a length direction of the pipe; and joint portions that are located at an end portion of the first partial pipe and at an end portion of the second partial pipe, and have an outer diameter larger than an outer diameter of each of the first partial pipe and the second partial pipe. The third fastening portion and the fourth fastening portion may be attached to each other at a position of the joint portion. According to this structure, during installing the thermal insulation structure, the third fastening portion and the fourth fastening portion may be attached to each other in a state where the third fastening portion and the fourth fastening portion are supported by the joint portion located inside the inside the first thermal insulation sheet and the third thermal insulation sheet. As a result, the installation work can be facilitated.
(12) In the thermal insulation structure according to any one of items (1) to (11), the one or more thermal insulation sheets may include at least one of a porous sheet, an inorganic fiber sheet, or a resin sheet.
(13) In the thermal insulation structure for a pipe according to any one of items (1) to (12), the one or more thermal insulation sheets may include a metal layer provided on an inner surface of the one or more thermal insulation sheets. According to this structure, the thermal insulation performance can be improved.
(14) A pipe heating system proposed in the present disclosure includes: the thermal insulation structure of any one of items (1) to (13); and the heater.
(15) A thermal insulation sheet proposed in the present disclosure is configured to cover an outside of a heater while ensuring an air layer between the heater covering a pipe and the thermal insulation sheet. The thermal insulation sheet includes: a first edge portion and a second edge portion located opposite to each other in a circumferential direction of the pipe; and a first fastening portion and a second fastening portion that are respectively provided at the first edge portion and the second edge portion of the thermal insulation sheet, and are attachable to and detachable from each other. According to this thermal insulation sheet, a plurality of thermal insulation sheets having the same structure can be used to cover the pipe. Further, since the first fastening portion and the second fastening portion are attachable to and detachable from each other, the installation work can be facilitated.
(16) A method of installing a thermal insulation structure, which is proposed in the present disclosure, includes: a first step of covering, with one or more thermal insulation sheets, an outside of a heater covering a pipe, and ensuring an air layer between the one or more thermal insulation sheets and the heater; and a second step of fixing a position of the one or more thermal insulation sheets through use of at least one fastening portion while ensuring the air layer. According to this installation method, power consumption of the heater can be reduced while maintaining the already installed heater. Since the air layer is used, sufficient thermal insulation performance can be ensured while reducing the thickness of the thermal insulation sheet.
(17) In the installation method according to item (16), the one or more thermal insulation sheets include, as the at least one fastening portion, a first fastening portion and a second fastening portion that are attachable to and detachable from each other, and in the second step, the first fastening portion and the second fastening portion are attached to each other to fix the position of the one or more thermal insulation sheets with respect to the heater. According to this method, since the first fastening portion and the second fastening portion are attachable to and detachable from each other, the installation work can be facilitated.

### BRIEF DESCRIPTION OF DRAWINGS

FIG. 1A is a perspective view for illustrating an example of a thermal insulation structure for a pipe, which is proposed in the present disclosure.

FIG. 1B is an enlarged view for illustrating a region 1b in FIG. 1A.

FIG. 2 is a perspective view for illustrating another example of the thermal insulation structure.

FIG. 3 is a developed view (plan view) for illustrating a thermal insulation sheet illustrated in FIG. 1A.

FIG. 4 is a sectional view for illustrating the thermal insulation sheet taken along the line IV-IV shown in FIG. 3.

FIG. 5A is a sectional view for illustrating the thermal insulation structure taken along a cutting plane extending along a length direction of a pipe.

FIG. 5B is an enlarged view for illustrating a region Vb illustrated in FIG. 5A.

FIG. 6 is a sectional view for illustrating a modification example of the thermal insulation structure for a pipe.

FIG. 7 is a perspective view for illustrating a modification example of the thermal insulation sheet.

FIG. 8 is a sectional view for illustrating another modification example of the thermal insulation sheet.

FIG. 9 is a schematic view for illustrating still another modification example of the thermal insulation sheet.

FIG. 10 is a schematic view for illustrating still another modification example of the thermal insulation sheet.

### DESCRIPTION OF EMBODIMENTS

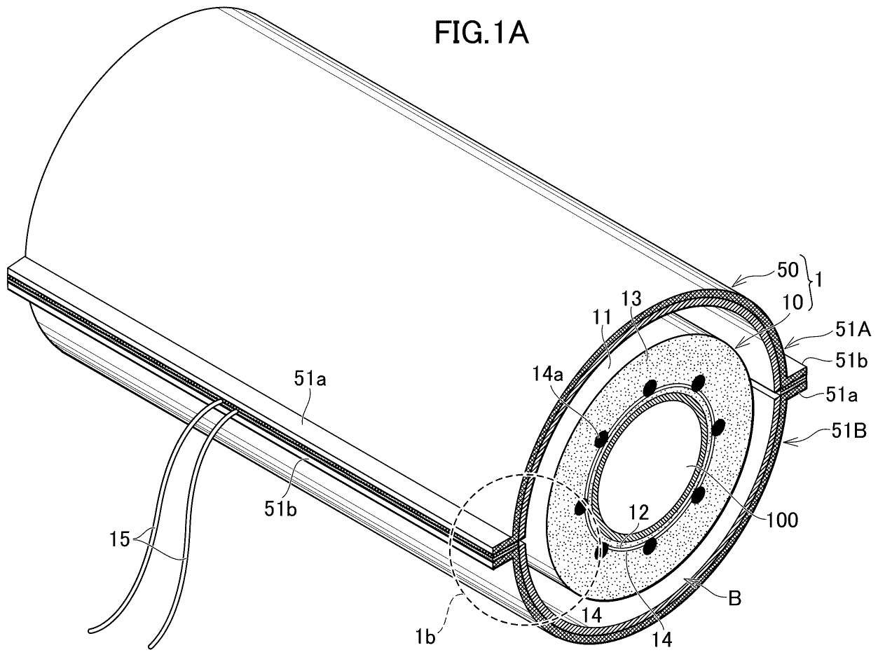

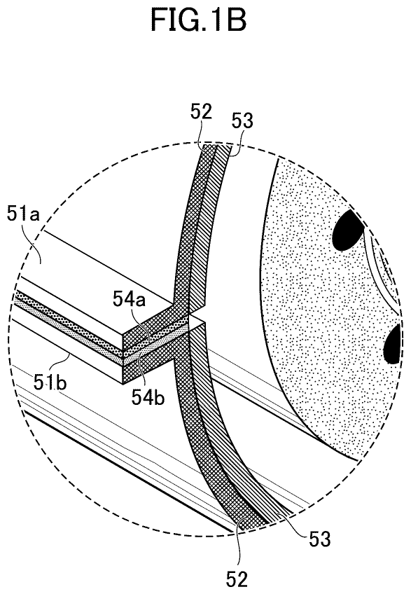

Hereinafter, description is given of a thermal insulation structure for a pipe, a pipe heating system, a thermal insulation sheet, and a method of installing a thermal insulation structure that are proposed in the present disclosure. In the present application, as an example, a pipe heating system 1, a thermal insulation structure 50, and thermal insulation sheets 51A and 51B, which are illustrated in FIG. 1A and the like, and a method of installing the thermal insulation structure 50 are described.

The pipe heating system 1 is applied to a pipe 100. The pipe 100 is, for example, a pipe provided in manufacturing facilities for semiconductors or flat panel displays. In a thin film forming step and an etching step in manufacture of semiconductors or flat panel displays, various gases are used, and exhaust gases are generated. The pipe heating system 1 heats the pipe 100, to thereby prevent a decrease in efficiency due to condensation of the supplied gas inside the pipe 100 and clogging of the pipe due to precipitation of the exhaust gas.

As illustrated in FIG. 1A, the pipe heating system 1 includes a heater 10 that covers the pipe 100, and the thermal insulation structure 50 that covers an outside of the heater 10.

### Heater

The heater 10 is a jacket heater, and has a tubular shape for covering the pipe 100. The heater 10 includes a thermal insulation material 13, an outer sheath 11 that covers an outside of the thermal insulation material 13, an inner sheath 12 that covers an inside of the thermal insulation material 13, and a cloth 14. Heat-generating wires 14a, which are a heat source, are sewn on the cloth 14. The heat-generating wires 14a are arranged along the inside of the thermal insulation material 13.

For example, a heat-resistant sheet (including a cloth) can be used as the outer sheath 11 and the inner sheath 12. The outer sheath 11 and the inner sheath 12 may be made of the same material or different materials. For example, a porous sheet, an inorganic fiber sheet, and a resin sheet can be used as the outer sheath 11 and the inner sheath 12. Examples of the porous sheet can include a polytetrafluoroethylene (PTFE) sheet. Examples of the inorganic fiber sheet can include a glass cloth. The resin sheet is, for example, a fluororesin sheet. Further, the porous sheet may be coated with a silicone or fluorine coating.

The thermal insulation material 13 is formed of, for example, flame-retardant fibers. The material of the thermal insulation material 13 may be an inorganic fiber or an organic fiber. The inorganic fiber may be, for example, a glass fiber, a ceramic fiber, or a silica fiber. The organic fiber may be, for example, aramid, polyamide, polyimide, or a fluororesin fiber.

The heat-generating wire 14a may be, for example, a resistor made of nickel-chromium-based metal. The heat-generating wire 14a is sewn on the cloth 14. The cloth 14 is, for example, a sheet made of an inorganic fiber such as a glass cloth. The heat-generating wires 14a are connected to a power Supply through lead wires 15.

The heater 10 may be flexible. That is, each of the thermal insulation material 13, the outer sheath 11, the inner sheath 12, and the cloth 14 that form the heater 10 may be flexible. In this case, in a step of installing the heater 10, the heater 10 is wrapped around the outside of the pipe 100 and becomes tubular. The heater 10 is not necessarily required to be flexible. In this case, the heater 10 may have an arc-shaped cross-section. A plurality of heaters 10 may be mounted to the outside of the pipe 100 to form a tubular heater as a whole. For example, each of the heaters 10 may be formed into a semi-cylindrical shape. In this case, two heaters 10 may be arranged so as to sandwich the pipe 100 therebetween, to thereby form a tubular heating device as a whole.

### Thermal Insulation Structure

As illustrated in FIG. 1A, the thermal insulation structure 50 includes the thermal insulation sheets 51A and 51B that cover the outside of the heater 10. The thermal insulation sheets 51A and 51B are tubular as a whole. The heater 10 and the pipe 100 are arranged inside the thermal insulation sheets 51A and 51B. An air layer B is ensured between the thermal insulation sheets 51A and 51B and the heater 10.

As illustrated in FIG. 1B, the thermal insulation sheets 51A and 51B each include a sheet base member 52. Further, the thermal insulation sheets 51A and 51B may each include a metal layer 53 formed on an inner surface of the sheet base member 52 (surface facing the heater 10 and the pipe 100). A reflection effect of the metal layer 53 can improve thermal insulation performance of the thermal insulation structure 50, and hence can further reduce power consumption of the heater 10. Further, the metal layer 53 is not exposed to an outer side of the thermal insulation sheet 51A or 51B, and hence the metal layer 53 can be prevented from being electrically charged.

The sheet base member 52 may be, for example, a porous sheet, an inorganic fiber sheet, or a resin sheet. As an example of the porous sheet, a sheet of porous polytetrafluoroethylene (PTFE) may be utilized. As an example of the inorganic fiber sheet, a glass cloth may be used.

The resin sheet is, for example, a sheet of a fluororesin. Examples of the fluororesin can include a tetrafluoroethylene-perfluoroalkoxy ethylene copolymer (PFA), a tetrafluoroethylene-hexafluoropropylene copolymer (FEP), polychlorotrifluoroethylene (PCTFE), a tetrafluoroethylene-ethylene copolymer (ETFE), a chlorotrifluoroethylene-ethylene copolymer (ECTFE), and polyvinylidene fluoride (PVDF). As a material of the resin sheet, there may be given, for example, polyamide, polycarbonate, polyacetal, polybutylene terephthalate, a modified polyphenylene ether, polyphenylene sulfide, polysulfone, polyethersulfone, polyarylate, polyether ether ketone, polyimide, polyether imide, and polymethylpentene.

The metal layer 53 may be, for example, a metal sheet (film). The metal is desirably, for example, a metal having high reflectance, such as aluminum or stainless steel. In this case, the metal layer 53 may be sewn on the inner surface of the sheet base member 52 with thread. The metal layer 53 may be bonded to the sheet base member 52 with an adhesive.

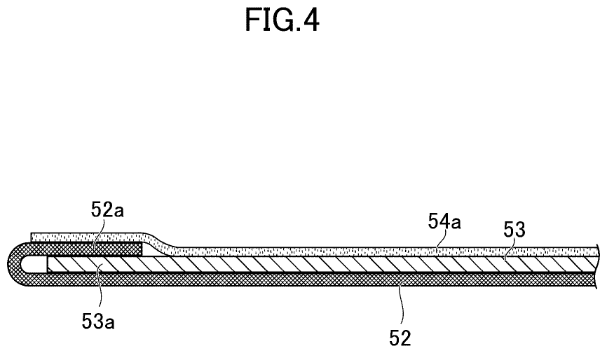

As illustrated in FIG. 4, an edge portion 52a of the sheet base member 52 may be folded back so as to cover an edge portion 53a of the metal layer 53, which is a metal sheet. (The edge portion 52a is hereinafter referred to as “folded edge portion”.) Then, the folded edge portion 52a may be sewn on the metal layer 53 and on a portion of the sheet base member 52 facing the folded edge portion 52a (portion located opposite to the folded edge portion 52a across the edge portion 53a of the metal layer 53). With this configuration, for example, during installing the thermal insulation structure 50, the edge portion 53a of the metal layer 53 is prevented from being caught on other members, thereby being capable of preventing injury at the edge portion.

The folded edge portion 52a may be, for example, an end portion in a length direction of the pipe 100 around which the thermal insulation sheets 51A and 51B are to be wrapped. Unlike this configuration, the folded edge portion 52a may be an edge portion in a circumferential direction of the pipe 100.

As described above, the metal layer 53 is formed of, for example, a metal sheet, and is sewn on the sheet base member 52 with thread. Unlike this configuration, the metal layer 53 may be formed by vapor deposition on the sheet base member 52. In addition, as another example, the metal layer 53 may be formed by vapor deposition on a resin sheet different from the sheet base member 52. The resin sheet may then be sewn on the sheet base member 52 with thread or bonded to the sheet base member 52 with an adhesive.

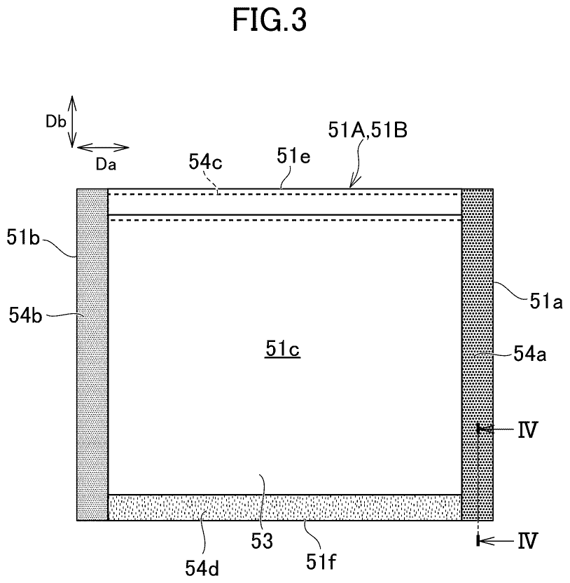

It is preferred that the thermal insulation sheets 51A and 51B be flexible. That is, the thermal insulation sheets 51A and 51B may be curved from a flat state as illustrated in FIG. 3 so as to conform to the outer surface of the heater 10 as illustrated in FIG. 1A. When such thermal insulation sheets 51A and 51B are used, the installation work for the thermal insulation structure 50 can be improved.

When the sheet base member 52 is, for example, a sheet of porous PTFE described above, its thickness may be 0.5 mm or more and 5.0 mm or less. Further, when the metal layer 53 is, for example, a sheet of aluminum, its thickness may be 0.01 mm or more and 0.7 mm or less. When the thermal insulation sheets 51A and 51B have such thicknesses, the thermal insulation sheets 51A and 51B can have sufficient flexibility. The thickness of the sheet base member 52, which is a sheet of porous PTFE, is preferably 0.5 mm or more and 2.0 mm or less. The thickness of the metal layer 53, which is a metal sheet, is preferably 0.01 mm or more and 0.2 mm or less.

The thicknesses of the thermal insulation sheets 51A and 51B may be smaller than the thickness of the heater 10. The thickness of the heater 10 may be, for example, from 20 mm to 30 mm. The thickness of the air layer B may be larger than the thicknesses of the thermal insulation sheets 51A and 51B. The thickness of the air layer B may be, for example, from 5 mm to 50 mm.

### Plurality of Thermal Insulation Sheets

In the example illustrated in FIG. 1A, the thermal insulation structure 50 covers one circumference of the pipe 100 with the two thermal insulation sheets 51A and 51B. That is, each of the thermal insulation sheets 51A and 51B has a semi-cylindrical shape in which the pipe 100 is centered, and the two thermal insulation sheets 51A and 51B are combined to form a tubular shape for covering the entire circumference of the pipe 100.

The two thermal insulation sheets 51A and 51B may have the Same structure. That is, the thermal insulation sheets 51A and 51B may have the same size (dimensions in the length direction and the circumferential direction of the pipe 100). Further, the thermal insulation sheets 51A and 51B may be the same in the mounting structure for fastening portions 54a and 54b described later and in the structure of the metal layer 53. This can reduce manufacturing cost of the thermal insulation structure 50.

In the following, when the two thermal insulation sheets 51A and 51B are distinguished from each other, the thermal insulation sheet 51A is referred to as “first thermal insulation sheet,” and the thermal insulation sheet 51B is referred to as “second thermal insulation sheet.”

The number of the thermal insulation sheets that cover the pipe 100 is not necessarily required to be two. Single thermal insulation sheet may cover the entire circumference of the pipe 100, or three or more thermal insulation sheets may cover the entire circumference of the pipe 100.

### Connection of Plurality of Thermal Insulation Sheets

As illustrated in FIG. 1A and FIG. 1B, the first thermal insulation sheet 51A includes fastening portions 54a and 54b that are respectively formed at two edge portions 51a and 51b located opposite to each other in the circumferential direction of the pipe 100. The edge portions 51a and 51b are hereinafter referred to as “fixed edge portions.” The second thermal insulation sheet 51B also includes fastening portions 54a and 54b that are respectively formed at two fixed edge portions 51a and 51b located opposite to each other in the circumferential direction of the pipe 100. The fastening portion 54a of the first thermal insulation sheet 51A and the fastening portion 54b of the second thermal insulation sheet 51B are attachable to and detachable from each other. That is, the fastening portions 54a and 54b are not portions that are mounted with a bolt or a screw. A worker can attach and detach the fastening portions 54a and 54b to and from each other without using a tool such as a screwdriver or a wrench. The fastening portion 54b of the first thermal insulation sheet 51A and the fastening portion 54a of the second thermal insulation sheet 51B are also attachable to and detachable from each other. The first thermal insulation sheet 51A and the second thermal insulation sheet 51B are connected to each other in the circumferential direction of the pipe 100 through use of the fastening portions 54a and 54b to form a tubular shape.

Hook-and-loop fasteners, for example, may be used as the fastening portions 54a and 54b. That is, the fastening portions 54a and 54b may be MAGICTAPE (trademark) or VELCRO (trademark). As described above, the thermal insulation sheets 51A and 51B each include the sheet base member 52. The hook-and-loop fastener, which is the fastening portion 54a or 54b, may be sewn on the folded edge portion 52a of the sheet base member 52 or bonded to the folded edge portion 52a of the sheet base member 52 with an adhesive.

When the hook-and-loop fasteners are used as the fastening portions 54a and 54b, the fastening portions 54a and 54b can be repeatedly attached to and detached from each other. Accordingly, the thermal insulation sheets 51A and 51B are allowed to be attached to and detached from the heater 10, thereby being capable of simplifying the installation work for the thermal insulation structure 50. Further, it is possible to adjust widths (widths in a radial direction of the pipe 100) of portions, which are attached to each other, of the fastening portions 54a and 54b. Through adjustment of the widths, one type of the thermal insulation sheets 51A and 51B can be used for a plurality of pipes with different outer diameters and a plurality of heaters 10 with different outer diameters.

The hook-and-loop fasteners, which are the fastening portions 54a and 54b, are provided on the fixed edge portions 51a and 51b extending in the radial direction of the pipe 100, but may also extend from the fixed edge portions 51a and 51b to reach the inner surface of the thermal insulation sheet 51A or 51B (inner surface of the metal layer 53). This increases the widths of the hook-and-loop fasteners, and thus can increase a structural flexibility in the sizes of the pipe 100 and the heater 10 to which the thermal insulation sheets 51A and 51B are applicable.

The fastening portions 54a and 54b may be continuous from one end portion of the fixed edge portions 51a and 51b of each of the thermal insulation sheets 51A and 51B to another end portion thereof. Unlike this configuration, the fastening portions 54a and 54b may be intermittently provided from one end portion of the fixed edge portions 51a and 51b to another end portion thereof. That is, a plurality of fastening portions 54a and 54b may be aligned along the fixed edge portions 51a and 51b.

Instead of the hook-and-loop fastener, a hook may be provided as the fastening portion 54a at the fixed edge portions 51a and 51b of each of the thermal insulation sheets 51A and 51B. In this case, the fastening portion 54b may be a hole or hook on which the hook is to be hooked. In addition, in another example, magnets may be provided as the fastening portions 54a and 54b. Even in those cases, the fastening portions 54a and 54b can be repeatedly attached to and detached from each other. Accordingly, the thermal insulation sheets 51A and 51B are allowed to be attached to and detached from the heater 10, thereby being capable of simplifying the installation work for the thermal insulation structure 50.

As illustrated in FIG. 3, the thermal insulation sheets 51A and 51B each have a front surface 51c. The front surface 51c is a surface including a surface (inner surface) that faces the pipe 100 when the thermal insulation sheets 51A and 51B are curved so as to cover the outside of the pipe 100. The above-mentioned metal layer 53 is provided on the front surface 51c. Both of the fastening portions 54a and 54b are attached on the front surface 51c.

When the thermal insulation sheets 51A and 51B are mounted to the pipe 100, as illustrated in FIG. 1B, the fixed edge portions 51a and 51b protrude toward a radially outer side of the pipe 100 from the tubular part of the thermal insulation sheets 51A and 51B. The fastening portions 54a and 54b face each other in the circumferential direction of the pipe 100, and are attached to each other. According to this structure, for example, as illustrated in FIG. 1A, it is easy to pull the lead wires 15 out from between the fixed edge portions 51a and 51b. The lead wires 15 are, for example, electric wires extending from the heat-generating wires 14a of the heater 10, or lead wires of a thermocouple or a thermostat used to control the heater 10.

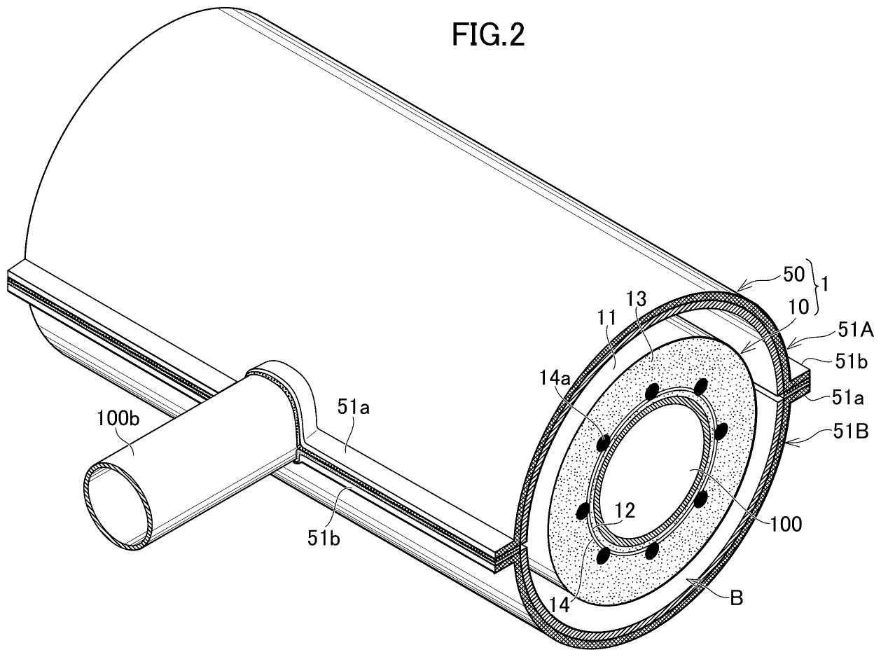

As illustrated in FIG. 2, a branch pipe 100b may be connected to the pipe 100. The branch pipe 100b extends from the pipe 100 in a direction intersecting the pipe 100. The branch pipe 100b extends to the radially outer side of the pipe 100 through a space between the fixed edge portions 51a and 51b (between the fastening portions 54a and 54b).

Since the fixed edge portions 51a and 51b and the fastening portions 54a and 54b extend toward the radially outer side of the pipe 100, the widths of the fixed edge portions 51a and 51b and the widths of the fastening portions 54a and 54b in the radial direction f the pipe 100 are easily ensured to be sufficient. As a result, a gap between the fastening portions 54a and 54b can be reduced even at a position of the lead wire 15 (FIG. 1A) and at a position of the branch pipe 100b (FIG. 2).

The locations of the fastening portions 54a and 54b are not limited to the example illustrated in FIG. 1A and the like. For example, in the example illustrated in FIG. 1A and the like, both of the fastening portions 54a and 54b are provided on the front surface 51c (surface including the inner surface that faces the pipe 100 when the thermal insulation sheets 51A and 51B are curved so as to cover the outside of the pipe 100). Unlike this configuration, one fastening portion 54a may be provided on the front surface 51c, and another fastening portion 54b may be provided on a back surface (surface including an outer peripheral surface that is directed opposite to the pipe 100 when the thermal insulation sheets 51A and 51B are curved so as to cover the outside of the pipe 100). In this case, when the fastening portions 54a and 54b are attached to each other, a part of one of the thermal insulation sheets 51A and 51B is disposed inside another one of the thermal insulation sheets.

### Structure for Ensuring Air Layer

As described above, the air layer B (FIG. 1A) is ensured between the thermal insulation sheets 51A and 51B and the outside of the heater 10. The air layer B can improve the thermal insulation performance of the thermal insulation structure 50.

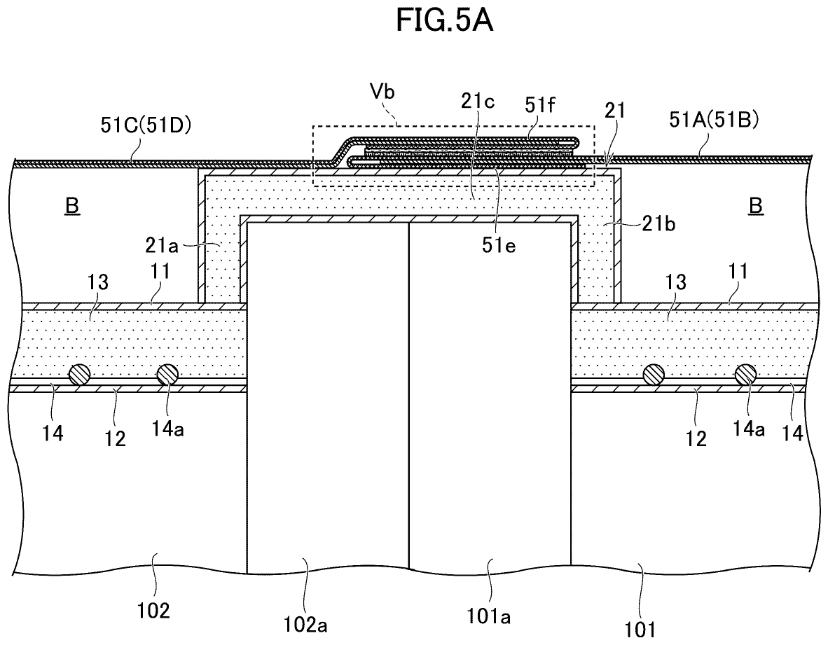

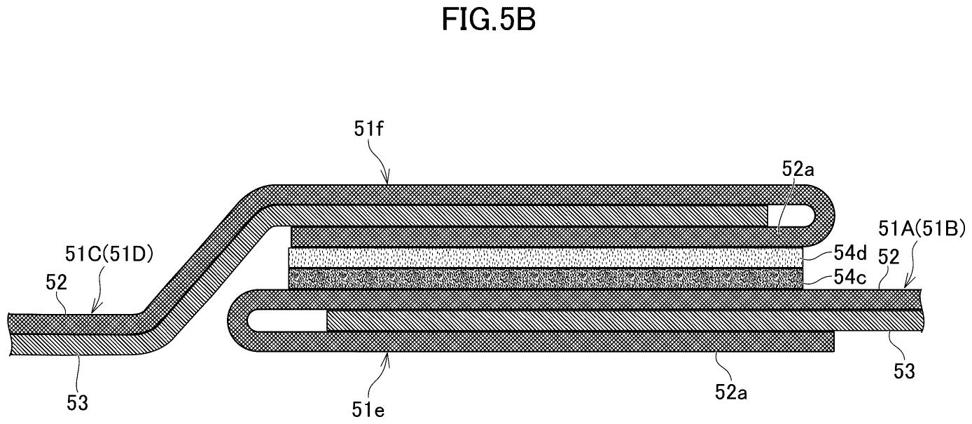

The air layer B may be ensured using the structure of the pipe 100. As illustrated in FIG. 5A, the pipe 100 includes a first partial pipe 101 and a second partial pipe 102 that are connected to each other in the length direction of the pipe 100. Joint portions 101a are provided at both end portions of the first partial pipe 101 in the longitudinal direction, respectively. Further, joint portions 102a are provided at both end portions of the second partial pipe 102 in the longitudinal direction, respectively. The partial pipes 101 and 102 are connected to each other through the joint portions 101a and 102a. The joint portions 101a and 102a are fixed to each other by, for example, a bolt or a clamping member. The joint portions 101a and 102a have a diameter larger than those of the partial pipes 101 and 102. The joint portion 101a of the partial pipe 101 and the joint portion 102a of the partial pipe 102 are located inside the thermal insulation sheets 51A and 51B, and therefore the insides of the thermal insulation sheets 51A and 51B are supported by the joint portions 101a and 102a. This allows the air layer B to be ensured without increasing the number of parts.

As illustrated in FIG. 5A, the thermal insulation structure 50 may include a joint heat-retaining portion 21 that surrounds the joint portions 101a and 102a. The joint heat-retaining portion 21 includes: side portions 21a and 21b that sandwich the joint portions 101a and 102a in the length direction of the pipe 100; and an annular portion 21c. The annular portion 21c surrounds the outsides of the joint portions 101a and 102a in the radial direction of the pipe 100. The thermal insulation sheets 51A and 51B are mounted to the outside of the joint heat-retaining portion 21 so as to surround the joint heat-retaining portion 21. According to this structure, the air layer B can be increased by an amount corresponding to the thickness of the annular portion 21c, thereby being capable of further improving the thermal insulation performance.

### Connection of Thermal Insulation Sheets in Length Direction of Pipe

As illustrated in FIG. 5A, the thermal insulation structure 50 includes thermal insulation sheets 51C and 51D that are connected to the thermal insulation sheets 51A and 51B in the length direction of the pipe 100. A third thermal insulation sheet 51C may be connected to the first thermal insulation sheet 51A, and a fourth thermal insulation sheet 51D may be connected to the second thermal insulation sheet 51B. The structures of the third thermal insulation sheet 51C and the fourth thermal insulation sheet 51D may be the same as those of the first thermal insulation sheet 51A and the second thermal insulation sheet 51B.

The joint portions 101a and 102a are located inside the third thermal insulation sheet 51C and the fourth thermal insulation sheet 51D, and therefore the insides of the third thermal insulation sheet 51C and the fourth thermal insulation sheet 51D are supported by the joint heat-retaining portion 21. This allows the air layer B to be also ensured inside the thermal insulation sheets 51C and 51D without increasing the number of parts.

In the example illustrated in FIG. 5A, edge portions 51e of the first thermal insulation sheets 51A and the second thermal insulation sheet 51B and edge portions 51f of the third thermal insulation sheet 51C and the fourth thermal insulation sheet 51D are located on an outer side of the joint portions 101a and 102a (radially outer side of the pipe 100). The edge portions 51e of the first thermal insulation sheet 51A and the second thermal insulation sheet 51B and the edge portions 51f of the third thermal insulation sheet 51C and the fourth thermal insulation sheet 51D are supported by the joint portions 101a and 102a, and overlap each other.

The hook-and-loop fasteners may also be used to connect the first thermal insulation sheet 51A and the second thermal insulation sheet 51B to the third thermal insulation sheet 51C and the fourth thermal insulation sheet 51D. As illustrated in FIG. 3, a fastening portion 54c, which is a hook-and-loop fastener, is attached on the edge portions 51e of the thermal insulation sheets 51A and 51B in the length direction of the pipe 100 (end portion in a direction indicated by the arrow Db in FIG. 3). The fastening portion 54c is attached on a surface (outer surface) that is directed opposite to the pipe 100 when the thermal insulation sheets 51A and 51B is curved so as to cover the outside of the pipe 100 (see FIG. 5B). A fastening portion 54d is attached on the edge portion 51f opposite to the edge portion 51e. This fastening portion 54d is attached on the front surface 51c. That is, the fastening portion 54d is attached on the surface (inner surface) that faces the pipe 100. The third thermal insulation sheet 51C and the fourth thermal insulation sheet 51D each include the fastening portions 54c and 54d in the same manner as in the case of the first thermal insulation sheet 51A and the second thermal insulation sheet 51B.

As illustrated in FIG. 5A and FIG. 5B, the edge portions 51e of the first thermal insulation sheet 51A and the second thermal insulation sheet 51B are located on the outer side of the joint portions 101a and 102a. The edge portions 51f of the third thermal insulation sheet 51C and the fourth thermal insulation sheet 51D are located on the outer side of the first thermal insulation sheet 51A and the second thermal insulation sheet 51B. The fastening portions 54c of the first thermal insulation sheet 51A and the second thermal insulation sheet 51B face the fastening portions 54d of the third thermal insulation sheet 51C and the fourth thermal insulation sheet 51D in the radial direction of the pipe 100, and are attached thereto.

According to this structure, when the thermal insulation sheets 51A to 51D are laid on the pipe, the fastening portions 54c and 54d can be attached to each other in a state where the edge portions 51e of the first thermal insulation sheet 51A and the second thermal insulation sheet 51B and the edge portions 51f of the third thermal insulation sheet 51C and the fourth thermal insulation sheet 51D are supported by the joint portions 101a and 102a. As a result, the installation work can be facilitated.

### Installation Method

An example of a method of installing the thermal insulation structure 50 is described. The heater 10 may be pre-mounted to the outside of the pipe 100.

A worker covers the outside of the heater 10 with the first thermal insulation sheet 51A and the second thermal insulation sheet 51B. At this time, the air layer B is ensured between each of the first thermal insulation sheet 51A and the second thermal insulation sheet 51B and the heater 10. The worker arranges the first thermal insulation sheet 51A and the second thermal insulation sheet 51B so that the both edge portions 51e and 51f of the first thermal insulation sheet 51A and the second thermal insulation sheet 51B cover the outside of the joint heat-retaining portion 21. Then, the worker attaches the fastening portion 54a (or fastening portion 54b), which has been attached on the fixed edge portion 51a (or 51b) of the first thermal insulation sheet 51A, and the fastening portion 54b (or fastening portion 54a), which has been attached on the fixed edge portion 51b (or 51a) of the second thermal insulation sheet 51B, to each other. This fixes the positions of the first thermal insulation sheet 51A and the second thermal insulation sheet 51B with respect to the heater 10 in a state where the air layer B is ensured between each of the first thermal insulation sheet 51A and the second thermal insulation sheet 51B and the heater 10.

The fixed edge portions 51a and 51b (fastening portions 54a and 54b) are protruded from the tubular part of the first thermal insulation sheet 51A and the second thermal insulation sheet 51B toward the radially outer side of the pipe 100. The worker attaches the fastening portions 54a and 54b to each other with the fastening portions 54a and 54b facing each other in the circumferential direction of the pipe 100. At this time, the lead wires 15 illustrated in FIG. 1A and the branch pipe 100b illustrated in FIG. 2 are located between the fastening portions 54a and 54b.

Single thermal insulation sheet or three or more thermal insulation sheets may surround the pipe 100. When single thermal insulation sheet is provided, the worker covers the entire circumference of the pipe 100 with this thermal insulation sheet, and attaches the fastening portions 54a and 54b, which are respectively provided at both ends of the thermal insulation sheet, to each other. For example, when three thermal insulation sheets are provided, the worker covers the entire circumference of the pipe 100 with the three thermal insulation sheets. Then, the worker attaches the fastening portion 54a, which is provided at the edge portion 51a of the thermal insulation sheet, and the fastening portion 54b, which is provided at the edge portion 51b of the adjacent thermal insulation sheet, to each other.

After attaching the first thermal insulation sheet 51A and the second thermal insulation sheet 51B to each other, the worker covers the outside of the heater 10 with the third thermal insulation sheet 51C and the fourth thermal insulation sheet 51D. At this time, the third thermal insulation sheet 51C and the fourth thermal insulation sheet 51D are arranged so that the both edge portions 51e and 51f of the third thermal insulation sheet 51C and the fourth thermal insulation sheet 51D cover the outside of the joint heat-retaining portion 21. Further, the worker connects the edge portions 51f (see FIG. 5B) of the third thermal insulation sheet 51C and the fourth thermal insulation sheet 51D to the edge portions 51e (see FIG. 5B) of the first thermal insulation sheet 51A and the second thermal insulation sheet 51B. That is, the worker arranges the edge portions 51f of the third thermal insulation sheet 51C and the fourth thermal insulation sheet 51D on the outer side of the edge portions 51e of the first thermal insulation sheet 51A and the second thermal insulation sheet 51B. Then, the fastening portion 54c at the edge portion 51e and the fastening portion 54d at the edge portion 51f are attached to each other. At this time, the edge portions 51e and 51f are supported by the joint portions 101a and 102a located on the inner side of the edge portions 51e and 51f. The worker performs such installation procedures in sequence along the pipe 100.

### Summary

As described above, the thermal insulation structure 50 includes the first thermal insulation sheet 51A and the second thermal insulation sheet 51B that cover the outside of the heater 10 mounted to the pipe 100 and ensure the air layer B between the heater 10 and each of the first thermal insulation sheet 51A and the second thermal insulation sheet 51B. The first thermal insulation sheet 51A and the second thermal insulation sheet 51B each include the fixed edge portions 51a and 51b located opposite to each other in the circumferential direction of the pipe 100. The fastening portions 54a and 54b are provided on the fixed edge portions 51a and 51b, respectively. The fastening portion 54a (or 54b) of the first thermal insulation sheet 51A and the fastening portion 54b (or 54a) of the second thermal insulation sheet 51B are attachable to and detachable from each other without using a tool such as a screwdriver or a wrench. When the fastening portion 54a (or 54b) of the first thermal insulation sheet 51A and the fastening portion 54b (or 54a) of the second thermal insulation sheet 51B are attached to each other, the first thermal insulation sheet 51A and the second thermal insulation sheet 51B cover the heater 10 and the pipe 100.

According to this structure, the power consumption of the heater 10 can be reduced while maintaining the already installed heater 10. Since the air layer B is used, sufficient thermal insulation performance can be ensured while the thicknesses of the thermal insulation sheets 51A and 51B are reduced. Further, since the two fastening portions 54a and 54b are attachable to and detachable from each other, the installation work can be facilitated.

The joint portions 101a and 102a of the pipe 100 are located inside the first thermal insulation sheet 51A and the second thermal insulation sheet 51B. According to this structure, the air layer B can be easily ensured.

The thermal insulation sheet 51A includes the fixed edge portions 51a and 51b that are located opposite to each other in the circumferential direction of the pipe 100. The fastening portions 54a and 54b, which are attachable to and detachable from each other, are provided on the fixed edge portions 51a and 51b, respectively. According to this thermal insulation sheet 51A, a plurality of thermal insulation sheets having the same structure (that is, the second thermal insulation sheet 51B, the third thermal insulation sheet 51C, and the fourth thermal insulation sheet 51D) can be used to cover the pipe 100. Further, since the fastening portions 54a and 54b are attachable to and detachable from each other, the installation work can be facilitated.

### Modification Example

The thermal insulation structure and the like proposed in the present disclosure are not limited to the examples described above.

For example, unlike the example illustrated in FIG. 5A, the thermal insulation structure 50 is not necessarily required to include the joint heat-retaining portion 21. In this case, the thermal insulation sheets 51A to 51D may be held in contact with the outer peripheral surfaces of the joint portions 101a and 102a of the pipe 100.

Further, the joint portions 101a and 102a are not necessarily required to be used to support the thermal insulation sheets 51A to 51D. In this case, a dedicated member for supporting the thermal insulation sheets 51A to 51D may be mounted to the outside of the heater 10. For example, an annular support member may be mounted to the outside of the heater 10. The thermal insulation sheets 51A to 51D may be mounted to an outside of this support member.

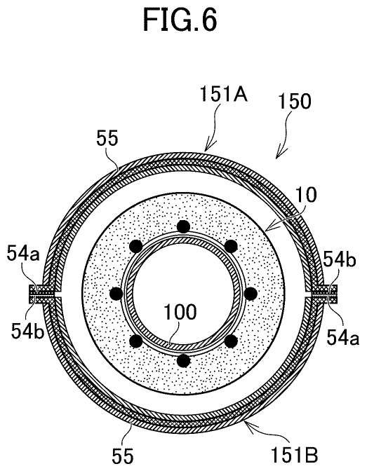

A metal layer may be formed not only on the inner surface of the thermal insulation sheet but also on an outer peripheral surface of the thermal insulation sheet. FIG. 6 is a sectional view for illustrating an example of a thermal insulation structure 150 including such a thermal insulation sheet. In the following, differences between the thermal insulation structure 150 and the thermal insulation structure 50 are mainly described. Matters not described for the thermal insulation structure 150 may be the same as those in the example of the thermal insulation structure 50.

The thermal insulation structure 150 includes thermal insulation sheets 151A and 151B. The thermal insulation sheets 151A and 151B each include a metal layer 55 in addition to the sheet base member 52 and the metal layer 53 described above. The metal layer 55 is provided on an outer peripheral surface of the sheet base member 52. The metal layer 55 is, for example, a metal film (sheet). In this case, for example, the metal layer 55 may be sewn on the sheet base member 52 with thread or bonded to the sheet base member 52 with an adhesive. Unlike this configuration, the metal layer 55 may be a resin sheet with metal formed on its surface by vapor deposition. In this case, the resin sheet may be sewn on the sheet base member 52 or bonded to the sheet base member 52 with an adhesive.

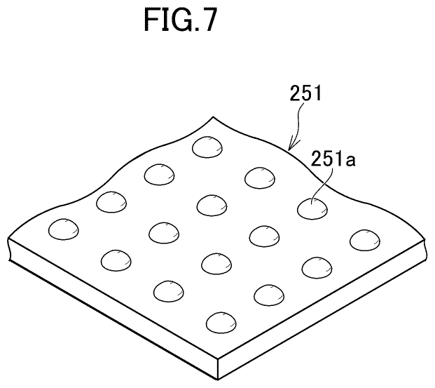

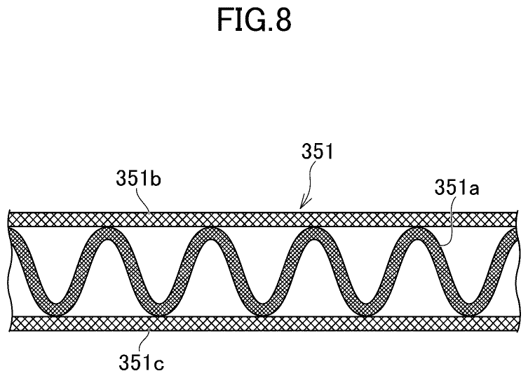

Further, in the thermal insulation structure 50 described above, the insides of the thermal insulation sheets 51A and 51B are supported by the joint portions 101a and 102a of the pipe 100, thereby ensuring the air layer B. Unlike this configuration, a structure for ensuring the air layer may be formed in a thermal insulation sheet. For example, as illustrated in FIG. 7, a plurality of projecting portions 251a may be formed on a thermal insulation sheet 251. Such projecting portions 251a may be formed by embossing. Further, as illustrated in FIG. 8, a thermal insulation sheet 351 may have the truss structure or the honeycomb structure. That is, the thermal insulation sheet 351 may include an outer sheet portion 351b, an inner sheet portion 351c, and a space portion 351a formed therebetween. The space portion 351a is a wavy sheet between the outer sheet portion 351b and the inner sheet portion 351c.

In the example illustrated in FIG. 1 and the like, the thermal insulation sheets 51A and 51B each include the fastening portions 54a and 54b provided at the fixed edge portions 51a and 51b, respectively. However, the locations of the fastening portions 54a and 54b are not necessarily required to be at the fixed edge portions 51a and 51b. For example, a first fastening portion provided on one end portion of the thermal insulation sheet in the circumferential direction of the pipe 100 may be attached to a second fastening portion provided on a middle portion of the thermal insulation sheet in the same circumferential direction of the pipe 100. In this case, the first fastening portion and the second fastening portion may be formed of hook-and-loop fasteners or the like, and may be attachable to and detachable from each other. Also in this case, the installation work for the thermal insulation sheet can be facilitated. Further, one type of thermal insulation sheets can be used for pipes and heaters with different diameters.

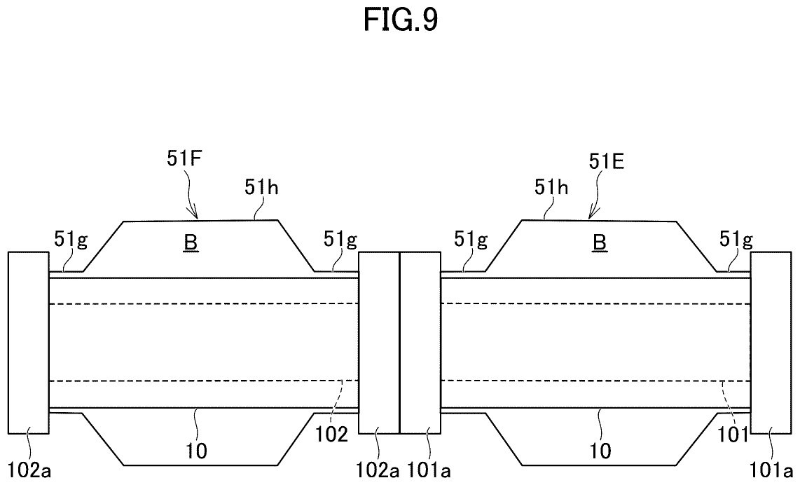

Further, as illustrated in FIG. 5A, the end portions of the thermal insulation sheets 51A and 51B in the length direction of the pipe 100 reach the joint portions 101a and 102a of the partial pipes 101 and 102, and cover the outsides of the joint portions 101a and 102a. Unlike this configuration, the thermal insulation sheet may be arranged between the joint portions provided at both end portions of each of the partial pipes 101 and 102. FIG. 9 is a schematic view for illustrating an example of such a thermal insulation sheet.

In FIG. 9, in the pipe 100, the first partial pipe 101 includes the joint portions 101a at both end portions thereof, and the second partial pipe 102 includes the joint portions 102a at both end portions thereof. A thermal insulation sheet 51E is arranged between the joint portions 101a at the both end portions of the first partial pipe 101. That is, edge portions 51g of the thermal insulation sheet 51E in the length direction of the pipe 100 are located between the joint portions 101a at the both end portions. Similarly, a thermal insulation sheet 51F is arranged between the joint portions 102a at the both end portions of the second partial pipe 102.

A diameter of the thermal insulation sheets 51E and 51F at the edge portion 51g corresponds to the outer diameter of the heater 10. Meanwhile, a portion 51h between the edge portions 51g in the thermal insulation sheets 51E or 51F has a diameter larger than that of the heater 10. Accordingly, the portion 51h ensures the air layer B between the outer peripheral surface of the heater 10 and the portion 51h. A spacer for ensuring the air layer B may be arranged between the portion 51h and the outer peripheral surface of the heater 10.

The edge portion 51g may be fixed to the heater 10 by, for example, a band or a string wrapped around the outside of the thermal insulation sheet 51E. Unlike this configuration, a fastening portion (for example, a hook-and-loop fastener) may be provided on an inner peripheral surface of the edge portion 51g, and a fastening portion (for example, a hook-and-loop fastener) may also be provided on the outer peripheral surface of the heater 10. The edge portion 51g may be mounted to the heater 10 by the fastening portions. In addition, as another example, the diameter of the thermal insulation sheet 51E at the edge portion 51g corresponds to the outer diameter of the heater 10, and hence the edge portion 51g is held in contact with the outer peripheral surface of the heater 10. This may fix the position of the thermal insulation sheet 51E or 51F with respect to the heater 10.

Each of the thermal insulation sheets 51E and 51F is not necessarily required to be a single thermal insulation sheet. That is, as illustrated in FIG. 1A and the like, each of the thermal insulation sheets 51E and 51F may be formed of a plurality of thermal insulation sheets connected together in the circumferential direction of the pipe 100.

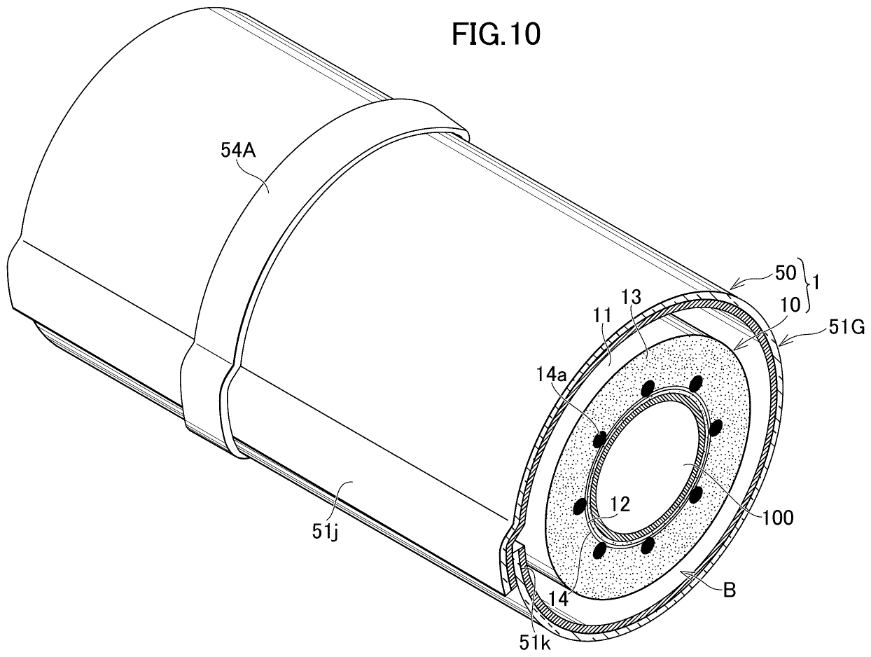

In the example illustrated in FIG. 1 and the like, the hook-and-loop fasteners attached to the fixed edge portions 51a and 51b of the thermal insulation sheets 51A and 51B are used as the fastening portions 54a and 54b. Unlike this configuration, the fastening portion may be a band or a string wrapped around the outside of the thermal insulation sheet. FIG. 10 is a perspective view for illustrating an example of such a mode. In the example illustrated in FIG. 10, single thermal insulation sheet 51G covers the entire circumference of the pipe 100. One edge portion 51j of the thermal insulation sheet 51G overlaps another edge portion 51k of the thermal insulation sheet 51G. A fastening portion 54A is a band that is wrapped around the outside of the thermal insulation sheet 51G to fix the position of this thermal insulation sheet 51G with respect to the heater 10.

The pipe 100 may be covered with a plurality of thermal insulation sheets aligned in the circumferential direction. The fastening portion 54A may be wrapped around the outsides of the plurality of thermal insulation sheets to fix positions of the thermal insulation sheets.

1. A thermal insulation structure for a pipe, comprising:
one or more thermal insulation sheets configured to cover an outside of a heater mounted to a pipe, and to ensure an air layer between the heater and the one or more thermal insulation sheets; and
at least one fastening portion configured to fix a position of the one or more thermal insulation sheets with respect to the heater while ensuring the air layer.

2. The thermal insulation structure for a pipe according to claim 1,
wherein the one or more thermal insulation sheets include, as the at least one fastening portion, a first fastening portion and a second fastening portion that are attachable to and detachable from each other, and
wherein the position of the one or more thermal insulation sheets is fixed with respect to the heater by attaching the first fastening portion and the second fastening portion to each other.

3. The thermal insulation structure for a pipe according to claim 2,
wherein the one or more thermal insulation sheets include a first edge portion and a second edge portion located opposite to each other in a circumferential direction of the pipe, and
wherein the first fastening portion and the second fastening portion are mounted to the first edge portion and the second edge portion, respectively.

4. The thermal insulation structure for a pipe according to claim 1,
wherein the pipe includes:
a first partial pipe and a second partial pipe that are connected to each other in a length direction of the pipe; and
joint portions that are located at an end portion of the first partial pipe and at an end portion of the second partial pipe, and have an outer diameter larger than an outer diameter of each of the first partial pipe and the second partial pipe, and
wherein the joint portions are located inside the one or more thermal insulation sheets.

5. The thermal insulation structure for a pipe according to claim 1,
wherein the pipe includes a plurality of partial pipes that are connected to each other in a length direction of the pipe,
wherein each of the plurality of partial pipes includes a first joint portion and a second joint portion that are respectively provided at one end portion and another end portion of each partial pipe so as to connect each partial pipe to an adjacent partial pipe, and
wherein the one or more thermal insulation sheets are arranged between the first joint portion and the second joint portion.

6. The thermal insulation structure for a pipe according to claim 2, wherein the first fastening portion and the second fastening portion include at least one of a hook-and-loop fastener, a magnet, or a hook.

7. The thermal insulation structure for a pipe according to claim 1, wherein the at least one fastening portion includes at least one of a band or a string that is configured to be wrapped around an outside of the one or more thermal insulation sheets to fix the position of the one or more thermal insulation sheets with respect to the heater.

8. The thermal insulation structure for a pipe according to claim 2,
wherein the one or more thermal insulation sheets include a first thermal insulation sheet including a first edge portion provided with the first fastening portion, and a second thermal insulation sheet including a second edge portion provided with the second fastening portion, and
wherein the first thermal insulation sheet and the second thermal insulation sheet are connected to each other in a circumferential direction of the pipe through use of the first fastening portion and the second fastening portion.

9. The thermal insulation structure for a pipe according to claim 8, wherein the first fastening portion and the second fastening portion protrude in a radial direction of the pipe and face each other in the circumferential direction of the pipe to be attached each other.

10. The thermal insulation structure for a pipe according to claim 1,
wherein the one or more thermal insulation sheets include a first thermal insulation sheet and a third thermal insulation sheet connected to each other in a length direction of the pipe,
wherein the first thermal insulation sheet includes a third edge portion in the length direction of the pipe, and a third fastening portion provided at the third edge portion,
wherein the third thermal insulation sheet includes a fourth edge portion in the length direction of the pipe, and a fourth fastening portion provided at the fourth edge portion, and
wherein the third fastening portion and the fourth fastening portion are attached to each other.

11. The thermal insulation structure for a pipe according to claim 10,
wherein the pipe includes:
a first partial pipe and a second partial pipe that are connected to each other in a length direction of the pipe; and
joint portions that are located at an end portion of the first partial pipe and at an end portion of the second partial pipe, and have an outer diameter larger than an outer diameter of each of the first partial pipe and the second partial pipe, and
wherein the third fastening portion and the fourth fastening portion are attached to each other at a position of the joint portions.

12. The thermal insulation structure for a pipe according to claim 1, wherein the one or more thermal insulation sheets include at least one of a porous sheet, an inorganic fiber sheet, or a resin sheet.

13. The thermal insulation structure for a pipe according to claim 1, wherein the one or more thermal insulation sheets include a metal layer provided on an inner surface of the one or more thermal insulation sheets.

14. A pipe heating system, comprising:
the thermal insulation structure according to claim 1; and
the heater.

15. A thermal insulation sheet, which is configured to cover an outside of a heater while ensuring an air layer between the heater covering a pipe and the thermal insulation sheet, the thermal insulation sheet comprising:
a first edge portion and a second edge portion located opposite to each other in a circumferential direction of the pipe; and
a first fastening portion and a second fastening portion that are respectively provided at the first edge portion and the second edge portion, and are attachable to and detachable from each other.

16. A method of installing a thermal insulation structure, the method comprising:
a first step of covering, with one or more thermal insulation sheets, an outside of a heater covering a pipe, and ensuring an air layer between the one or more thermal insulation sheets and the heater; and
a second step of fixing a position of the one or more thermal insulation sheets through use of at least one fastening portion while ensuring the air layer.

17. The method of installing a thermal insulation structure according to claim 16,
wherein the one or more thermal insulation sheets include, as the at least one fastening portion, a first fastening portion and a second fastening portion that are attachable to and detachable from each other, and
wherein, in the second step, the first fastening portion and the second fastening portion are attached to each other to fix the position of the one or more thermal insulation sheets with respect to the heater.
